(19) United States
(12) Patent Application Publication
(10) Pub. No.: US 2006/0238936 A1
(43) Pub. Date: Oct. 26, 2006

(54) Apparatus and method for transient blocking employing relays

(76) Inventors: Richard A. Blanchard, Los Altos, CA (US); Richard A. Harris, Palo Alto, CA (US); Francois Hebert, San Mateo, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/410,575

(22) Filed: Apr. 24, 2006

Related U.S. Application Data
(60) Provisional application No. 60/675,075, filed on Apr. 25, 2005.

(51) Int. Cl. H02H 9/00

(52) U.S. Cl. 361/56

(57) ABSTRACT

An apparatus and a method for uni-directional and bi-directional transient blocking. The uni-directional apparatus has a depletion mode n-channel device at its input and a normally closed relay, e.g., a micro-electro-mechanical (MEM) relay, interconnected with the depletion mode n-channel device and the input in such a way that at a predetermined current value the transient causes the normally closed relay to switch into an open state and apply a bias voltage Vₙ on the depletion mode n-channel device that is sufficiently high to switch it “off” thus block the transient. An analogous arrangement at the output taking advantage of the same or a second relay renders the apparatus bi-directional. The structure of the apparatus and the method of operation ensure a reliable and repeatable trip current Iₜᵣᵢₚ and render the apparatus very robust and feasible for low-cost manufacture.

### RELATED APPLICATIONS

The present application claims priority from provisional U.S. application 60/675,075 that was filed on 25 Apr. 2005 and is herein incorporated in its entirety.

### FIELD OF THE INVENTION

This invention relates generally to a transient blocking apparatus and methods that employ relays in conjunction with depletion mode devices for uni-directional and bi-directional protection against transients.

### BACKGROUND ART

Many circuits, networks, electrical devices and data handling systems are operated in configurations and environments where external factors can impair their performance, cause failure or even result in permanent damage. Among the most common of these factors are over-voltage and over-current transients. Protection against these is important and has been addressed in the prior art in a number of ways, depending on the specific electronics and their application.

Fuses that employ thermal or magnetic elements are one common protection measure. For example, some circuits employ relays in their systems to cause protective blocking in either direction. Exemplary prior art protection circuits that use relays, including circuits with MOSFETs, include U.S. Pat. Nos. 4,453,191; 4,484,245; 5,536,980; 5,926,354; 6,373,670; 6,759,835 and 6,891,705.

Protection circuits are further specialized depending on conditions and application. For example, in the case of protecting batteries or rechargeable elements from overcharging and over-discharging one can refer to circuit solutions described in U.S. Pat. Nos. 5,789,900; 6,313,610; 6,331,763; 6,518,731; 6,914,416; 6,948,078; 6,958,591 and U.S. Published Application 2001/00210192. Still other protection circuits, e.g., ones associated with power converters for IC circuits and devices that need to control device parameters and electric parameters simultaneously also use these elements. Examples can be found in U.S. Pat. Nos. 5,929,665; 6,768,623; 6,855,988; 6,861,828.

When providing protection for very sensitive circuits, such as those encountered in telecommunications the performance parameters of the fuses and protection circuits are frequently insufficient. A prior art solution which satisfies a number of the constraints and is embodied in a transient blocking unit (TBU) is taught in international applications PCT/AU94/00358; PCT/AU04/00117; PCT/AU03/00175; PCT/AU03/00848 as well as U.S. Pat. Nos. 4,533,970; 5,742,463 and related literature cited in these references.

One significant theoretical limitation of the TBU is that it relies on the use of both n-channel and p-channel field effect transistors (FETs). While n-channel FETs with the correct characteristics can be manufactured quite easily, p-channel FETs with low resistance and moderate breakdown voltage are expensive. The theoretical limiting factor involved in making the p-channel FET is that the mobility of carriers in p-channel material is considerably lower than that in n-channel material. For these reasons, building large volumes of TBUs with low series resistance, low voltage drop and a reliable and repeatable trip current Iₜᵣᵢₚ results in a price-performance trade-off that limits the number of applications for which this solution is appropriate.

### OBJECTS AND ADVANTAGES

In view of the above prior art limitations, it is an object of the invention to provide an transient blocking apparatus that has a low series resistance, low voltage drop and is sufficiently low-cost to be feasible for additional high volume applications.

It is another object of the invention to ensure that the apparatus have a very reliable and repeatable trip current Iₜᵣᵢₚ and be highly robust.

Still another object of the invention is to provide for a method for transient blocking that can be employed for uni-directional or bi-directional blocking at lower cost than TBUs containing p-channel FETs.

These and other objects and advantages of the invention will become apparent from the ensuing description.

### SUMMARY OF THE INVENTION

The objects and advantages of the invention are addressed by an apparatus for blocking a transient, and by a method for implementing transient blocking. The apparatus has a depletion mode n-channel device located at its input. A normally closed relay is interconnected with the depletion mode n-channel device and the input in such a way that at a predetermined current value the transient causes the normally closed relay to switch into an open state and apply a bias voltage Vₙ on the depletion mode n-channel device that is sufficiently high to switch off the depletion mode n-channel device and thus block the transient. The depletion mode n-channel device used in the apparatus of invention is preferably a high-voltage depletion mode device such as a high-voltage metal-oxide-semiconductor field effect transistor (MOSFET).

The normally closed relay that is particularly well-suited for the apparatus of the invention is a micro-electro-mechanical relay or MEM relay. The relay has a series resistor R₁ and a parallel resistor R₂, where R₂>R₁. Alternatively, a single shunt resistor having a certain shunt resistance Rₛ can be connected across the relay. The shunt resistance Rₛ should be selected sufficiently high to result in an acceptable current leakage through the relay. In still other embodiments or the same embodiments, the apparatus is further equipped with a protective element for protecting the depletion mode n-channel device. More specifically, when an NMOS transistor plays the role of the depletion mode n-channel device the protective element can be a Zener or an avalanche diode connected between its source and gate terminals. Alternative components that can be used as a protective element include bipolar transistors wired as diodes, MOSFETs wired as diodes and polysilicon diodes.

The apparatus can be rendered bi-directional, i.e., it can be easily adapted to block transients of either polarity. To accomplish this, an additional depletion mode n-channel device is placed at an output of the apparatus and interconnected to block a reverse transient. More precisely, the additional depletion mode n-channel device is interconnected with the normally closed relay such that at a certain reverse current value the reverse transient causes the switching of the normally closed relay into an open state, thereby producing a bias voltage Vₙ on additional depletion mode n-channel device that switches off the additional device and thus blocks the reverse transient. As in the previous cases, a protective element such as a diode can be used to protect the additional device.

The method of invention calls for providing a transient blocking apparatus with a depletion mode n-channel device at an input of the transient blocking apparatus. In another step, a normally closed relay is interconnected with the depletion mode n-channel device and the input in such a way, that at a certain current value the transient induces the switching of the normally closed relay to an open state. Once the relay is switched to its open state, the consequent bias voltage Vₙ on the depletion mode n-channel device causes the device to switch off and thus block the transient.

Preferably, the method is practiced in situations where the normally closed relay has a series resistor R₁ and a parallel resistor R₂, such that R₂>R₁. In some embodiments, a shunt resistor having a shunt resistance Rₛ is connected across the normally closed relay in order to minimize current leakage. In the same or other embodiments, protective elements can be connected to the depletion mode n-channel device. Also, the method can be extended to bi-directional transient blocking by providing an additional depletion mode n-channel device at an output of the transient blocking unit so that it can block a reverse transient, i.e., a transient of opposite polarity.

A detailed description of the preferred embodiments of the invention is presented below in reference to the appended drawing figures.

### BRIEF DESCRIPTION OF THE DRAWING FIGURES

FIG. 1 is a diagram illustrating the basic principle of operation of a prior art uni-directional transient blocking unit (TBU).

FIG. 2 is a diagram illustrating the basic principle of operation of a prior art bi-directional TBU.

FIG. 3 is a diagram showing a uni-directional transient blocking apparatus in accordance with the invention.

FIG. 4A is a graph illustrating the voltage vs. current characteristics of the apparatus of FIG. 3.

FIG. 4B is a graph illustrating the voltage vs. current characteristics of a prior art apparatus according to FIG. 1.

FIG. 5 is a diagram of another uni-directional transient blocking apparatus in accordance with the invention.

FIG. 6 is a diagram of a bi-directional transient blocking apparatus employing two normally closed relays according to the invention.

FIG. 7 is a diagram of a bi-directional transient blocking apparatus employing a single normally closed relay according to the invention.

FIG. 8 is a diagram of another bi-directional transient blocking apparatus employing a single normally closed relay according to the invention.

FIG. 9 is a diagram of the bi-directional apparatus of FIG. 8 equipped with protective elements for the depletion mode n-channel devices.

FIG. 10 is a diagram of the bi-directional apparatus of FIG. 8 employing a shunt resistor.

### DETAILED DESCRIPTION

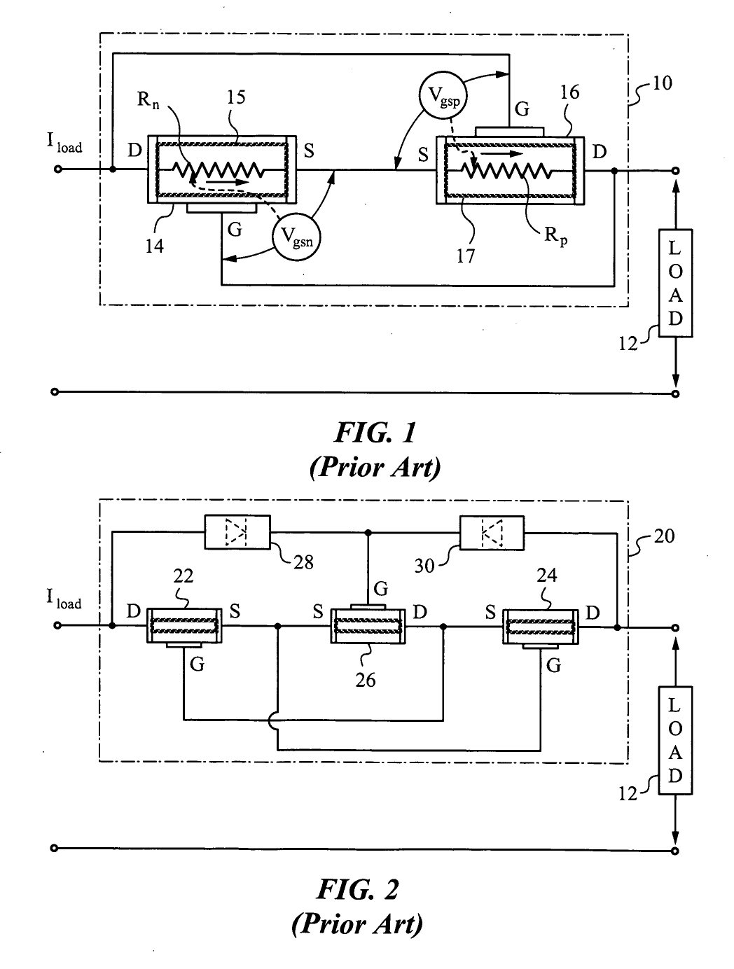

The present invention and its principles will be best understood by first reviewing prior art uni-directional and bi-directional transient blocking units (TBUs) designed for over-voltage and over-current protection. The diagram in FIG. 1 shows a prior art TBU 10 for protecting a load 12 from voltage and/or current transients of one polarity, i.e., positive voltage spikes or surges. For this reason, TBU 10 is called uni-directional. TBU 10 uses a depletion mode n-channel device 14 and a depletion mode p-channel device 16, both of which can be implemented by field effect transistors (FETs). Devices 14, 16 are interconnected to take advantage of their n-channel and p-channel biasing and resistance properties to cause mutual switch off to block the transient.

More specifically, devices 14, 16 have corresponding n- and p-channels 15, 17 as well as gate G, source S and drain D terminals. Resistances Rₙ, Rₚ of devices 14, 16 are low when voltage differences or bias voltages V_{gsn} and V_{gsp} between their gate G and source S terminals are zero. Normally, TBU 10 is unblocked and devices 14, 16 act as small resistors that allow a load current I_{load} to pass to load 12. Application of negative bias V_{gsn} to n-channel device 14 and positive bias V_{gsp} to p-channel device 16 increases resistances Rₙ, Rₚ, as indicated by the arrows and turns devices 14, 16 off. The interconnection of devices 14, 16 source-to-source and gate-to-drain reinforces the process of biasing both devices “off” in response to a transient. Specifically, as load current I_{load} increases device 16 develops a larger voltage drop across it, thus increasing negative bias V_{gsn} applied to device 14 and consequently increasing resistance Rₙ. Higher resistance Rₙ increases positive bias V_{gsp} on device 16 thereby increasing Rₚ. Thus, the transient alters bias voltages V_{gsn} and V_{gsp} in concert, such that devices 14, 16 mutually increase their resistances Rₙ, Rₚ and switch “off”, and thus TBU 10 blocks the transient.

The above principle of interconnection of n- and p-channel devices to achieve mutual switch-off (sometimes also referred to as mutual pinch-off) is extended to bi-directional TBUs by using two uni-directional TBUs with one configured in reverse to block negative spikes. A simpler, bi-directional TBU 20 that protects load 12 from negative and positive spikes, is shown in FIG. 2. TBU 20 has two n-channel devices 22, 24 and one p-channel device 26. Devices 22, 24, 26 are interconnected between their gate G, source S and drain D terminals as shown. Two current limiters 28, 30 are used to ensure appropriate routing of current between devices 22, 24, 26. Current limiters 28, 30 can be diodes, resistors, transistors, current sources or combinations thereof. TBU 20 causes mutual switch off of devices 22, 24, 26 in response to a negative or positive spike by employing the principles of controlling resistances by biasing in response to transients as explained above.

In fact, the prior art teaches a number of variants of TBUs based on the above principles. These include, among other, TBUs that use p-channel devices at inputs, a larger number of n-channel or p-channel devices as well as TBUs that employ high-voltage depletion devices. More detailed information about prior art TBUs and associated applications and methods can be found in published literature including, in particular, PCT/AU94/00358; PCT/AU04/00117; PCT/AU03/00175; PCT/AU03/00848; PCT/AU03/01326 and U.S. Pat. No. 5,742,463 that are herein incorporated by reference.

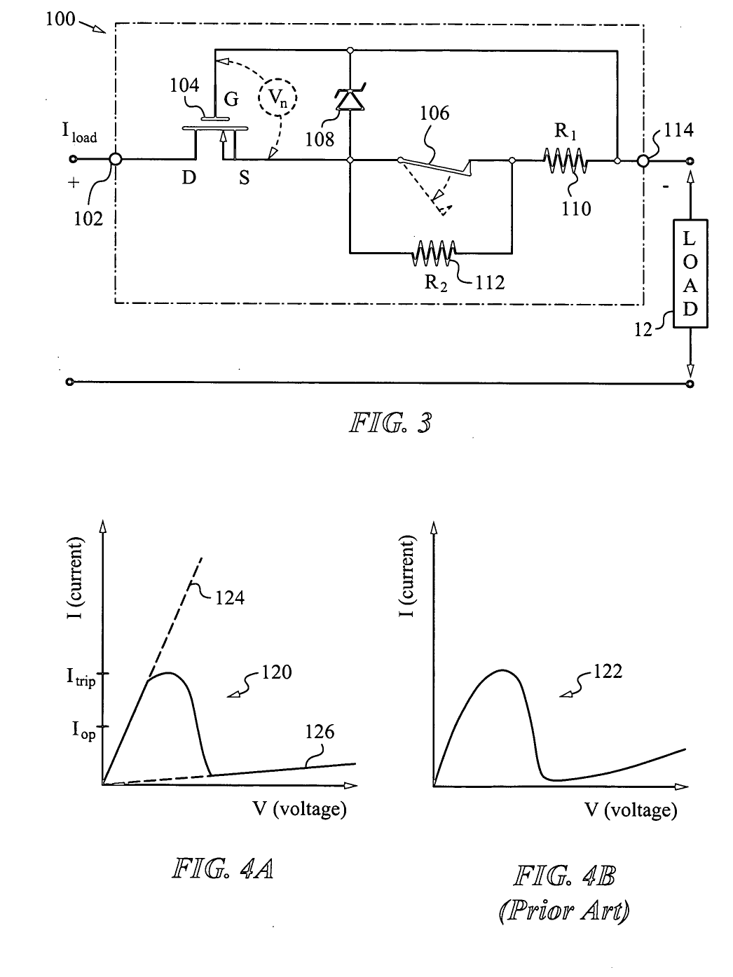

FIG. 3 illustrates a uni-polar or uni-directional apparatus 100 for blocking an over-voltage or transient in accordance with the invention. Apparatus 100 has an input 102 at which a load current I_{load} of positive polarity is applied. A depletion mode n-channel device 104 is connected to input 102 by its drain D terminal. Preferably, device 104 is a high-voltage n-channel metal-oxide-semiconductor field effect transistor (MOSFET). In fact, in the embodiment shown, depletion mode n-channel MOSFET 104 is exposed to the maximum rated voltage of apparatus 100, and should thus have a voltage rating corresponding to the desired maximum rating.

A normally closed relay 106 is interconnected with MOSFET 104 and indirectly with input 102 via device 104. Specifically, relay 106 is connected directly to source S terminal of MOSFET 104 and to its gate G terminal via a diode 108. Diode 108 is preferably an avalanche diode and is provided to prevent excessive voltage spikes on gate G terminal of MOSFET 104 from causing damage or circuit malfunction.

It should be noted, that since relay 106 is interconnected with gate G and source S terminals of MOSFET 104, it is not directly exposed to the high voltages associated with transients that appear at drain D of MOSFET 104. As a result, relay 106 is preferably designed to have a low withstand voltage. This is advantageous, because low withstand voltage relays can be manufactured extremely inexpensively. In addition, because of size and performance reasons, relay 106 is preferably not an electromechanical relay, but rather a MEM relay that is activated piezo-electrically or in some other fashion, including electrostatically or magnetically. More specifically, although conventional electromechanical relays can be used in apparatus 100, their size will limit the usefulness of such apparatus. Also, conventional relays commonly use coil-based magnetic activation and the coil is wired from input to output of the relay device. Thus, the finite resistance of the coil places a cap on the maximum resistance of such relay device in the open or off-state.

Normally closed relay 106 has a series resistor 110 with a series resistance R₁ and a parallel resistor 112 with a parallel resistance R₂. Series resistor 110 and gate G terminal of MOSFET 104 are both connected to an output 114 of apparatus 100. The resistance values are chosen such that parallel resistance R₂ is larger than series resistance R₁, i.e., R₂>R₁. Series resistor 110 provides the voltage at gate G terminal of MOSFET 104. It is the voltage level at gate G that switches the normally “on” MOSFET 104 to its off state at a certain current level or trip current Iₜᵣᵢₚ.

During operation, the interconnection of relay 106, depletion mode MOSFET 104 and input 102 ensures that at a predetermined current value a transient causes normally closed relay 106 to switch into an open state. This causes a bias voltage Vₙ to be applied on MOSFET 104 that is sufficiently high to switch off it off and thus block the transient. The details of this action will be best understood by referring to a graph illustrating the transition of relay 106 from closed state to open state, as shown in FIG. 4A. Specifically, a voltage versus current curve 120 in FIG. 4A shows the transition occurring at a trip current Iₜᵣᵢₚ that is sufficient to trip relay 106 into open state.

For comparison purposes, FIG. 4B shows a typical voltage versus current curve 122 for a uni-directional prior art TBU 10 of FIG. 1. Note the linear behavior of I-V curve 120 in an operating range 124, i.e., at current values around a typical operating current Iₒₚ. Such linear behavior is very predictable and desirable. On the other hand, the behavior of prior art I-V curve 122 in the same range is not linear. Furthermore, once relay 106 is tripped into open state at trip current Iₜᵣᵢₚ, I-V curve 120 settles into a blocked range 126 that is also linear. Once again, this is not true for I-V curve 122 of the prior art TBU. More precisely, in operating range 124 when relay 106 is closed, the total resistance Rₜₒₜ of apparatus 100 is:
Rₜₒₜ=R_{FET}+R₁, (eq. 1)
Where R_{FET} is the resistance of MOSFET 104. Upon tripping of relay 106 into open state, the total resistance increases to:
Rₜₒₜ=R_{FET}+R₂+R₁. (eq. 2)
This increase in resistance is so large, that it effectively blocks the current passing through apparatus 100 to output 114. As seen from blocked range 126, the slope of I-V curve 120 in this range is very small and linear.

Due to the construction and operation parameters in accordance with the invention, transient blocking apparatus 100 has a low series resistance, low voltage drop and is sufficiently low-cost to be feasible for volume manufacture. In addition, as confirmed by I-V curve 120, apparatus 100 ensures a very reliable and repeatable trip current Iₜᵣᵢₚ.

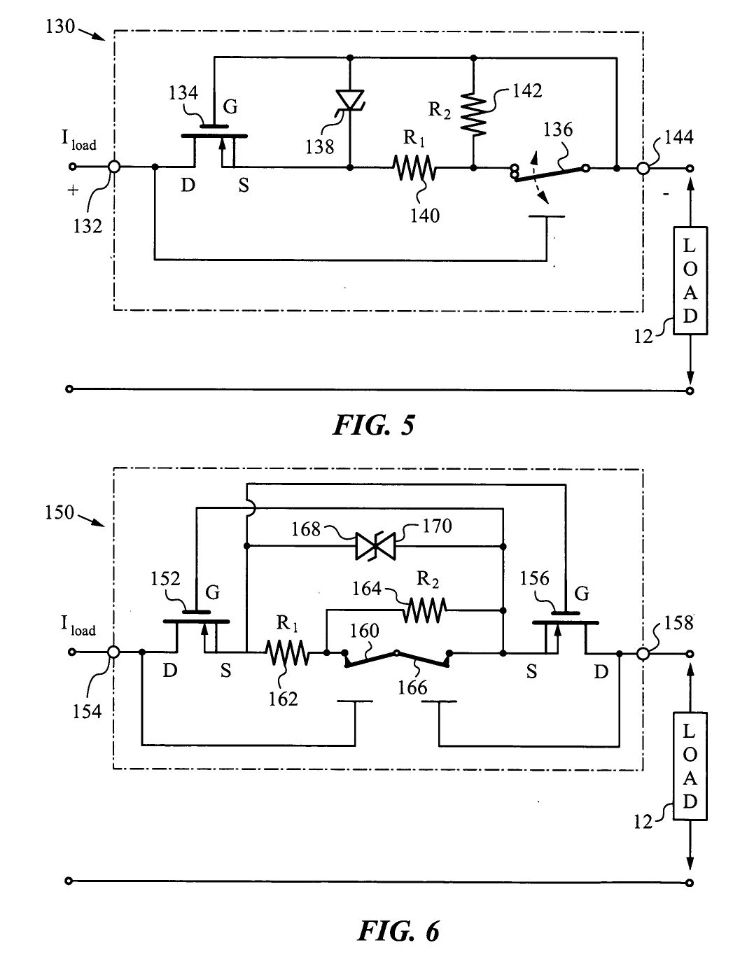

FIG. 5 illustrates another uni-directional transient blocking apparatus 130 with an input 132, a MOSFET 134 and a normally closed relay 136. Apparatus 130 also uses an avalanche diode 138, a series resistor 140 and a parallel resistor 142 in a configuration similar to the one described above. Load 12 is connected to an output 144 of apparatus 130.

In this embodiment, relay 136 is a small MEM relay that may be activated electrostatically, piezo-electrically, magnetically or in some other fashion. In the preferred case, its manufacture is compatible with MOSFET 134. Relay 136 can consist of many parallel paths, such as individual cantilevers or similar structures that each carry a fraction of the current. A person skilled in the art will also appreciate that the use of a “redundant” relay structure with many parallel paths can result in increased manufacturing yield, decreased resistance and increased reliability, since a small number of these parallel paths that are either permanently “closed” or permanently “open” will not affect circuit operation.

In contrast to the above embodiment, relay 136 is driven by a voltage across the total circuit of apparatus 130 from input 132 to output 144 rather than the voltage drop from gate G to the output. For this reason, relay 136 is connected directly to input 132. The individual parallel paths can be designed to operate at different “speeds” to provide a stepped transition from the normally “closed” to “open” state. The purpose of stepping the transition is to moderate it so as to minimize transient effects in the circuits of load 12, which apparatus 130 is protecting.

Of course, the basic principles taught above in uni-directional apparatus can be extended to bi-directional apparatus for blocking forward and reverse transients. FIG. 6 shows an exemplary bi-directional transient blocking apparatus 150. To block transients of either polarity apparatus 150 is equipped with a depletion mode n-channel device 152 at an input 154 and an additional depletion mode n-channel device 156 identical to device 152, at an output 158 of apparatus 150. Device 152 is interconnected with a normally closed relay 160 and input 154. Relay 160 has a series resistor 162 having a resistance R₁ and a parallel resistor 164 having a resistance R₂ such that R₂>R₁. Additional device 156 takes advantage of same resistors 162, 164, and is interconnected with a normally closed relay 166 and output 158. Note that in this embodiment both relays 160, 166 have a control that is piezo-electric, electrostatic or magnetic and that they are connected directly to input 154 and output 158, respectively. A pair of diodes 168, 170 is provided to prevent excessive voltage spikes on gate G terminals of devices 152 and 156 from causing damage or circuit malfunction.

In accordance with the invention, the above interconnections ensure that at certain forward current value, namely Iₜᵣᵢₚ, a forward transient causes the switching of normally closed relay 160 into an open state. This action produces a bias voltage Vₙ between gate G and source S terminals of device 152 and thus causes it to switch off thereby blocking the forward transient. At a certain reverse current value, which in this embodiment happens to be equal to the forward current value, namely Iₜᵣᵢₚ, a reverse transient causes the switching of normally closed relay 166 into an open state. This causes a bias voltage Vₙ to be applied between gate G and source S terminals of additional device 156. The bias causes additional device 156 to switch off and thus block the reverse transient.

A person skilled in the art will recognize that bi-directional apparatus 150 can be symmetric in the sense that Iₜᵣᵢₚ is the same for forward and reverse currents or non-symmetric, depending on application. Additionally, although both relays 160, 166 in this embodiment are of the MEM type, regular relays can be employed as well. Moreover, relays 160, 166 used in bi-directional apparatus 150 do not have to be connected directly to input 154 and output 158. Instead, in an alternative embodiment they could be connected to source S terminals of devices 152, 154, respectively so as to not expose them to the full rated voltage. Irrespective of the interconnection of relays 160, 166, it is preferable that both devices 152, 154 be high-voltage MOSFETs.

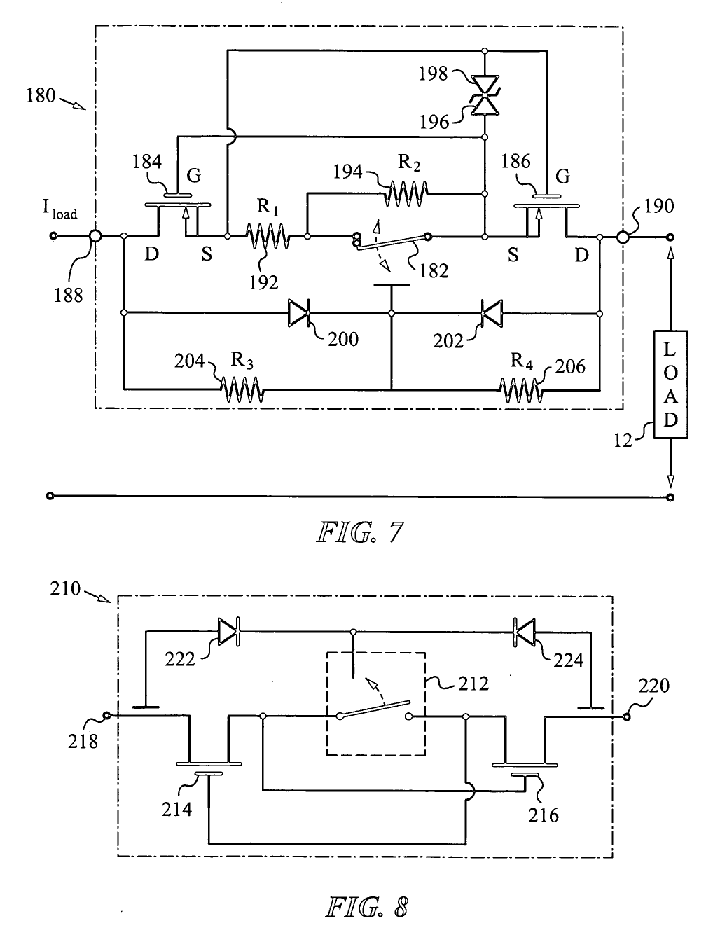

FIG. 7 shows another embodiment of a bi-directional transient blocking apparatus 180. Apparatus 180 uses a single, normally closed MEM relay 182 that has a piezo-electric, electrostatic or magnetic control and has a number of parallel current paths. To ensure bi-directional transient blocking, apparatus 180 has a depletion mode n-channel device 184 and an additional depletion mode n-channel device 186. Devices 184, 186 are preferably high-voltage MOSFETs and they are interconnected with relay 182 as well as an input 188 and an output 190 as shown.

Apparatus 180 employs a series resistor 192 and a parallel resistor 194 for controlling the switch-off characteristics of relay 182 in the manner described above. Two avalanche diodes 196, 198 are used to protect against excessive voltage spikes and damage. Further, in order to adapt single relay 182 for bi-directional operation, additional diodes 200, 202 and resistors 204, 206 are employed to establish both the voltage and its polarity at the control terminal of relay 182. It should be noted that irrespective of whether the control is piezo-electric, electrostatic or magnetic, relay 182 be operated by current of either polarity.

FIG. 8 illustrates still another embodiment of a bi-directional transient blocking apparatus 210 employing a single normally closed MEM relay 212. The control of relay 212 is either piezo-electrical, electrostatic, magnetically or other suitable control mechanism. Apparatus 210 has two n-channel MOSFETs 214, 216 interconnected with relay 212 as well as with an input 218 and an output 220, respectively. In order to provide for better protection, electrostatic control of relay 212 is provided with capacitive contacts at input 218 and output 220. In addition, diodes 222 and 224 are provided to ensure proper current flow.

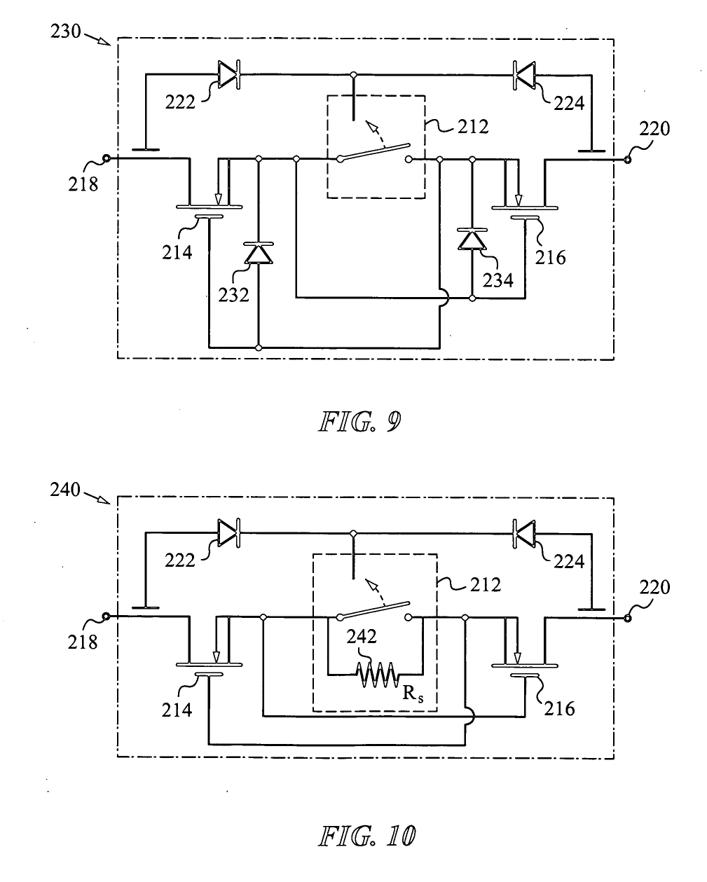

Under some circumstances, since source S terminal of MOSFET 214 is connected to gate G terminal of MOSFET 216, the circuit may experience failures due to biasing conditions of MOSFET 214 in forward operation, or due to biasing conditions of MOSFET 216 in reverse operation. For this reason, FIG. 9 illustrates an apparatus 230 which is similar to apparatus 210, but is further equipped with protective elements 232 and 234. Note that the same reference numbers are used for corresponding parts in this drawing figure.

In the present embodiment protective elements 232, 234 are diodes connected across gate G and source S terminals of MOSFET 214 and MOSFET 216. Under normal operating conditions, when no transients are present, relay 212 at input 218 is closed (on state) and diode 232 is forward biased. This maintains MOSFET 214 in the on state. Meanwhile, diode 234 at output 220 is reverse biased, which protects gate G of MOSFET 216.

When a forward transient occurs, the rising voltage (dV/dt) at input 218 couples to the control terminal of relay 212 and causes it to open (off state). Now, as the voltage across relay 212 rises, the bias voltage applied on MOSFET 214 will become more negative, which switches MOSFET 214 off. Because of to diode 232, the maximum bias voltage applied to MOSFET 214 is limited. As gate G potential drops, source S bias is maintained at a low potential through forward biased diode 234 at output 220. The same situation occurs in reverse in the case of a reverse transient. It is preferred that diodes 232, 234 be avalanche or Zener diodes, in order to limit the bias voltage even as breakdown voltage is reached. Zener type diodes should be used with NMOS devices that have relatively thin gate oxides and bias voltages in the 5 V or smaller range. Avalanche diodes should be employed for devices with thicker gate oxides. As will be appreciated by those skilled in the art, other components can be used to fulfill the protective function for n-channel devices. Some example alternatives include bipolar transistors wired as diodes, MOSFETs wired as diodes and polysilicon diodes.

Still another way to help with biasing of source S terminals of depletion mode n-channel devices used in transient blocking apparatus according to the invention involves a shunt resistor. FIG. 10 illustrates an apparatus 240 similar to apparatus 210, and uses the same reference numerals for corresponding parts. In apparatus 240 a shunt resistor 242 is connected across relay 212. Of course, as will be understood by one skilled in the art, the shunt resistance Rₛ of shunt resistor 242 has to be sufficiently high to minimize current leakage. It should also be noted that both protective measures—shunt resistor and gate protective elements—can be used simultaneously in alternative embodiments.

Among the many advantages of the method and apparatus of invention is the feasibility of the circuit design and its compatibility with volume manufacturing. In fact, depending on the style of NMOS transistors used and the voltage rating of the apparatus all of the elements, with possible exception of the relay, can be integrated in one die. The layout can be done such that the relay can be easily connected, and coupling elements for the switch may be included in the die as well.

A system employing any apparatus in accordance to the invention can be applied to protect load 12 from transients. In particular, the apparatus of invention, both in its uni-directional and bi-directional embodiments has the requisite protection characteristic to be used with sensitive load 12. For example, load 12 can be a telephonic circuit, an opto-electronic circuit or any high-fidelity circuit in general. A person skilled in the art will be able to determine the protection parameters and further adapt the apparatus of invention to any particular system that requires highly reliable and robust transient protection.

Furthermore, while MEM relays that are controlled piezo-electrically, electrostatically or magnetically are called out explicitly, other control techniques that cause the relay to open mechanically may also be employed. In addition, even though depletion mode NMOS FETs are mentioned explicitly, the devices can include any normally on solid state device that can be switched off and is capable of withstanding the maximum transient voltages.

Many other embodiments of the apparatus and method are possible. Therefore, the scope of the invention should be judged by the appended claims and their legal equivalents.

We claim:

1. An apparatus for blocking a transient, said apparatus comprising:
a) a depletion mode n-channel device at an input of said apparatus;
b) a normally closed relay interconnected with said depletion mode n-channel device and said input such that at a predetermined current value said transient switches said normally closed relay to an open state, thereby producing a bias voltage Vₙ on said depletion mode n-channel device that switches off said depletion mode n-channel device to block said transient.

2. The apparatus of claim 1, wherein said depletion mode n-channel device comprises a high-voltage depletion mode device.

3. The apparatus of claim 2, wherein said high-voltage depletion mode device comprises a metal-oxide-semiconductor field effect transistor.

4. The apparatus of claim 1, wherein said normally closed relay comprises a micro-electro-mechanical relay.

5. The apparatus of claim 4, wherein said micro-electro-mechanical relay comprises a number of parallel paths.

6. The apparatus of claim 4, said micro-electro-mechanical relay comprises a control selected from the group consisting of electromechanical, piezo-electric, electrostatic and magnetic.

7. The apparatus of claim 1, wherein said normally closed relay has a series resistor R₁ and a parallel resistor R₂, where R₂>R₁.

8. The apparatus of claim 1, further comprising a shunt resistor having a shunt resistance Rₛ connected across said normally closed relay, said shunt resistance Rₛ being sufficient to produce an acceptable current leakage through said normally closed relay.

9. The apparatus of claim 1, further comprising a protective element connected to said depletion mode n-channel device.

10. The apparatus of claim 9, wherein said depletion mode n-channel device is an NMOS transistor and said protective element comprises a diode connected between a source and a gate of said NMOS transistor.

11. The apparatus of claim 10, wherein said diode is selected from the group consisting of Zener diodes, avalanche diodes, bipolar transistors wired as diodes, MOSFETs wired as diodes and polysilicon diodes.

12. The apparatus of claim 1, further comprising an additional depletion mode n-channel device at an output of said transient blocking unit for rendering said apparatus bi-directional such that it blocks a reverse transient.

13. The apparatus of claim 12, wherein said additional depletion mode n-channel device is interconnected with said normally closed relay such that at a predetermined reverse current value said reverse transient switches said normally closed relay to an open state, thereby producing a bias voltage Vₙ on said additional depletion mode n-channel device that switches off said additional depletion mode n-channel device to block said reverse transient.

14. The apparatus of claim 13, further comprising a protective element connected to said additional depletion mode n-channel device.

15. The apparatus of claim 14, wherein said additional depletion mode n-channel device is an NMOS transistor and said protective element comprises a diode connected between a source and a gate of said NMOS transistor.

16. A method for transient blocking comprising:
a) providing a transient blocking apparatus;
b) providing a depletion mode n-channel device at an input of said transient blocking apparatus;
c) interconnecting a normally closed relay with said depletion mode n-channel device and said input such that at a predetermined current value said transient switches said normally closed relay to an open state, thereby producing a bias voltage Vₙ on said depletion mode n-channel device that switches off said depletion mode n-channel device to block said transient.

17. The method of claim 16, further comprising providing said normally closed relay with a series resistor R₁ and a parallel resistor R₂, where R₂>R₁.

18. The method of claim 16, further comprising providing a shunt resistor having a shunt resistance Rₛ connected across said normally closed relay, said shunt resistance Rₛ being sufficiently high to produce and acceptable current leakage through said normally closed relay.

19. The method of claim 16, further comprising connecting a protective element to said depletion mode n-channel device.

20. The method of claim 16, further comprising providing an additional depletion mode n-channel device at an output of said transient blocking unit for blocking a reverse transient thereby rendering said method bi-directional.

21. The method of claim 20, further comprising interconnecting said additional depletion mode n-channel device with said normally closed relay such that at a predetermined reverse current value said reverse transient switches said normally closed relay to an open state, thereby producing a bias voltage Vₙ on said additional depletion mode n-channel device that switches off said additional depletion mode n-channel device to block said reverse transient.

22. The method of claim 21, further comprising connecting a protective element to said additional depletion mode n-channel device.

23. A system comprising a load and an apparatus for blocking a transient to said load, said apparatus comprising:
a) a depletion mode n-channel device at an input of said apparatus;
b) a normally closed relay interconnected with said depletion mode n-channel device and said input such that at a predetermined current value said transient switches said normally closed relay to an open state, thereby producing a bias voltage Vₙ on said depletion mode n-channel device that switches off said depletion mode n-channel device to block said transient.

24. The system of claim 23, wherein said load is selected from the group consisting of telephonic circuits, opto-electronic circuits and high-fidelity circuits.
